(19) United States
(12) Patent Application Publication
(10) Pub. No.: US 2025/0068183 A1
(43) Pub. Date: Feb. 27, 2025

(54) Service Decision Method and Service Decision Device

(71) Applicants: Tsinghua University, Beijing City (CN); Technology Innovation Institute - Sole Proprietorship LLC, Masdar City (AE)

(72) Inventors: Jun DU, Beijing (CN); Hualei ZHANG, Beijing (CN); Yu TIAN, Shenzen (CN); Jintao WANG, Beijing (CN); Bingqing JIANG, Beijing (CN); Xiangwang HOU, Beijing (CN); Zhaoyue XIA, Beijing (CN); Ahmed AL HAMMADI, Masdar City (AE); Aymen FAKHREDDINE, Masdar City (AE)

(73) Assignees: Tsinghua University, Bejing City (CN); Technology Innovation Institute - Sole Proprietorship LLC, Masdar City (AE)

(21) Appl. No.: 18/809,998

(22) Filed: Aug. 20, 2024

(30) Foreign Application Priority Data
Aug. 24, 2023 (CN) 202311072553.3

(51) Int. Cl. G05D 1/69

(52) U.S. Cl. CPC G05D 1/69

(57) ABSTRACT

The present application relates to a service decision method and a service decision device. The method includes: receiving a task request sent by a terminal, the task request including a terminal identifier, terminal location information and task information of the terminal; determining that the terminal is currently in an overlapping coverage area, generating a decision-making instruction according to the task request and a target decision network, and sending the decision-making instruction to the terminal according to the terminal identifier, the decision-making instruction being used to indicate whether a target unmanned aerial vehicle server provides to the terminal a service corresponding to the task request, and the target decision-making instruction being used by the terminal to select one server from among the target unmanned aerial vehicle server and the other unmanned aerial vehicle servers to provide the service. Using the present method can improve resource utilization.

### FIELD OF INVENTION

The present application relates to the technical field of artificial intelligence, and in particular, to a service decision method and a service decision device.

### BACKGROUND

With the development of computer technology, more and more terminal devices are appearing in people's daily lives. Typically, many application programs are installed in a terminal. When a user uses the application programs installed in the terminal, more and more computing resources or bandwidth is needed in order to satisfy computing requirements. Thus, mobile edge computing (MEC) has emerged. That is, when a terminal needs to perform computing for a certain task having high resource requirements, the task may be offloaded to an MEC server, thereby reducing the computing load on the terminal and a delay and energy consumption caused by task execution.

In remote areas, typically, an unmanned aerial vehicle server having an MEC function provides mobile edge computing service to a terminal in the area. In an actual scenario, when a plurality of unmanned aerial vehicle servers provide mobile edge computing service in the same area, coverage areas of the unmanned aerial vehicle servers overlap. When the plurality of unmanned aerial vehicle servers provide mobile edge computing service for a terminal in an overlapping area, the problem of waste of resources occurs.

### SUMMARY

On that basis, in view of the above technical problem, it is necessary to provide a service decision method and a service decision device that can improve resource utilization.

In a first aspect, the present application provides a service decision method. The method is used for a target unmanned aerial vehicle server, an overlapping coverage area being present between the target unmanned aerial vehicle server and another unmanned aerial vehicle server. The method comprises:
Receiving a task request sent by a terminal, the task request comprising a terminal identifier, terminal location information and task information of the terminal; and
If it is determined, on the basis of the terminal location information, that the terminal is currently in the overlapping coverage area, generating a target decision-making instruction according to the task request and a target decision network, and sending the target decision-making instruction to the terminal according to the terminal identifier,
The target decision-making instruction being used to indicate whether the target unmanned aerial vehicle server provides to the terminal a service corresponding to the task request, and the target decision-making instruction being used by the terminal to select, according to the target decision-making instruction and a decision-making instruction sent by the other unmanned aerial vehicle server, one server from among the target unmanned aerial vehicle server and the other unmanned aerial vehicle server to provide the service.

In one embodiment, generating a target decision-making instruction according to the task request and a target decision network comprises: acquiring current status information of the target unmanned aerial vehicle server;
Inputting the status information and the task request into the target decision network as current environmental observation data of the target unmanned aerial vehicle server to obtain decision data outputted by the target decision network, the decision data comprising action decision information of the target unmanned aerial vehicle server for the task request, computing resources and bandwidth allocated by the target unmanned aerial vehicle server for the task request, and an expected execution delay; and
Generating the target decision-making instruction according to the decision data.

In one embodiment, the status information comprises server location information of the target unmanned aerial vehicle server, currently available resource information of the target unmanned aerial vehicle server, currently available bandwidth information of the target unmanned aerial vehicle server, and the number of covered users corresponding to the target unmanned aerial vehicle server and the overlapping coverage area.

In one embodiment, when the target decision-making instruction indicates that the target unmanned aerial vehicle server provides the service to the terminal, the method further comprises:

Receiving task data sent by the terminal on the basis of the target decision-making instruction, and performing task processing on the task data according to the target decision-making instruction, so as to provide to the terminal the service corresponding to the task request.

In one embodiment, the method further comprises:

In a plurality of training slots, iteratively training an initial decision network on the basis of initial sample environmental observation data corresponding to each training slot, so as to obtain the target decision network, the initial sample environmental observation data comprising a sample task request and sample status information.

In one embodiment, iteratively training an initial decision network on the basis of initial sample environmental observation data corresponding to each training slot, so as to obtain the target decision, network comprises:
In a target training slot, for a single iteration process, inputting first intermediate sample environmental observation data corresponding to the iteration process into an intermediate decision network to obtain intermediate decision data outputted by the intermediate decision network;
Inputting the intermediate decision data into at least one evaluation network to obtain an evaluation value outputted by the evaluation network for the intermediate decision data, the evaluation value being determined on the basis of a target reward and penalty value for the intermediate decision data; and
Adjusting a network parameter of the evaluation network according to the evaluation value, so that the target decision network is obtained after a plurality of iteration processes in each training slot are finished.

In one embodiment, after inputting the intermediate decision data into at least one evaluation network to obtain an evaluation value outputted by the evaluation network for the intermediate decision data, the method further comprises:
Acquiring second intermediate sample environmental observation data, the second intermediate sample environmental observation data being sample environmental observation data of an iteration process following the iteration process corresponding to the first intermediate sample environmental observation data; and
Storing the first intermediate sample environmental observation data, the intermediate decision data, the target reward and penalty value, and the second intermediate sample environmental observation data in an experience pool as empirical values of the iteration process corresponding to the first intermediate sample environmental observation data;
The experience pool comprising the empirical values corresponding to the target unmanned aerial vehicle server and the other unmanned aerial vehicle server.

In one embodiment, the method further comprises:

After a plurality of iteration processes in the target training slot are finished, adjusting a network parameter of the intermediate decision network on the basis of the empirical values in the experience pool, so as to obtain the target decision network.

In one embodiment, inputting the intermediate decision data into at least one evaluation network, to obtain an evaluation value outputted by the evaluation network for the intermediate decision data, comprises:
Inputting the intermediate decision data into at least one evaluation network to obtain reward and penalty values corresponding to a plurality of reward and penalty constraint conditions, the reward and penalty constraint conditions comprising at least one of a restrictive condition on the number of users served by the target unmanned aerial vehicle server, a restrictive condition on computing resource allocation by the target unmanned aerial vehicle server, a restrictive condition on bandwidth allocation by the target unmanned aerial vehicle server, a restrictive condition on a task execution delay of the target unmanned aerial vehicle server, and a restrictive condition on a delay corresponding to each training slot; and
Acquiring the target reward and penalty value for the intermediate decision data according to each reward and penalty value, and acquiring the evaluation value according to the target reward and penalty value.

In one embodiment, the evaluation network comprises a first evaluation network and a second evaluation network, and the evaluation value comprises a first evaluation value outputted by the first evaluation network and a second evaluation value outputted by the second evaluation network, adjusting a network parameter of the evaluation network according to the evaluation value further comprising:
Comparing the magnitudes of the first evaluation value and the second evaluation value, and using the smallest evaluation value among the first evaluation value and the second evaluation value as a current evaluation value; and
Acquiring an error result before the current evaluation value and a target evaluation value, and using a difference learning method to adjust a network parameter of the first evaluation network and adjust a network parameter of the second evaluation network on the basis of the error result.

In a second aspect, the present application provides a service decision method. The method is used for a terminal in an overlapping coverage area of a plurality of unmanned aerial vehicle servers. The method comprises:
Sending a task request to each unmanned aerial vehicle server, the task request comprising a terminal identifier, terminal location information and task information of the terminal; and
Receiving a decision-making instruction sent by each unmanned aerial vehicle server, and selecting, according to an indication of each decision-making instruction as to whether the unmanned aerial vehicle server provides to the terminal a service corresponding to the task request, one server from among the unmanned aerial vehicle servers to provide the service,
The decision-making instructions being generated by the unmanned aerial vehicle servers according to the task requests and a target decision network.

In a third aspect, the present application provides a service decision device. The device is used for a target unmanned aerial vehicle server, and an overlapping coverage area is present between the target unmanned aerial vehicle server and another unmanned aerial vehicle server. The device comprises:
A receiving module, used to receive a task request sent by a terminal, the task request comprising a terminal identifier, terminal location information, and task information of the terminal; and
A decision module, used to, if it is determined, on the basis of the terminal location information, that the terminal is currently in the overlapping coverage area, generate a target decision-making instruction according to the task request and a target decision network, and send the target decision-making instruction to the terminal according to the terminal identifier, the target decision-making instruction being used to indicate whether the target unmanned aerial vehicle server provides to the terminal a service corresponding to the task request, and the target decision-making instruction being used by the terminal to select, according to the target decision-making instruction and a decision-making instruction sent by the other unmanned aerial vehicle server, one server from among the target unmanned aerial vehicle server and the other unmanned aerial vehicle server to provide the service.

In a fourth aspect, the present application provides a service decision device. The device is used for a terminal in an overlapping coverage area of a plurality of unmanned aerial vehicle servers. The device comprises:
A sending module, used to send a task request to each unmanned aerial vehicle server, the task request comprising a terminal identifier, terminal location information and task information of the terminal; and
A receiving module, used to receive a decision-making instruction sent by each unmanned aerial vehicle server, and select, according to an indication of each decision-making instruction as to whether the unmanned aerial vehicle server provides to the terminal a service corresponding to the task request, one server from among the unmanned aerial vehicle servers to provide the service,
The decision-making instructions being generated by the unmanned aerial vehicle servers according to the task requests and a target decision network.

In a fifth aspect, the present application further provides a computer device. The computer device comprises a memory and a processor, the memory storing a computer program, and the processor, when executing the computer program, implementing the steps of the method according to the first or second aspect.

In a sixth aspect, the present application further provides a computer-readable storage medium. The computer-readable storage medium stores a computer program, and the computer program, when executed by a processor, implements the steps of the method according to the first or second aspect.

In a seventh aspect, the present application further provides a computer program product. The computer program product comprises a computer program, and the computer program, when executed by a processor executed by a processor, implements the steps of the method according to the first or second aspect.

In the service decision method and a service decision device, a task request sent by a terminal is received, the task request comprising a terminal identifier, terminal location information and task information of the terminal, and then if it is determined, on the basis of the terminal location information, that the terminal is currently in an overlapping coverage area, a target decision-making instruction is generated according to the task request and a target decision network, and is sent to the terminal according to the terminal identifier, the target decision-making instruction being used to indicate whether a target unmanned aerial vehicle server provides to the terminal a service corresponding to the task request, and the target decision-making instruction being used by the terminal to select, according to the target decision-making instruction and a decision-making instruction sent by another unmanned aerial vehicle server, one server from among the target unmanned aerial vehicle server and the other unmanned aerial vehicle server to provide the service. In this way, upon receiving a task request of a terminal, each unmanned aerial vehicle server (comprising a target unmanned aerial vehicle server and another unmanned aerial vehicle server) corresponding to an overlapping coverage area does not directly provide to the terminal a service corresponding to the task request, but generates a decision-making instruction on the basis of a trained target decision network. The decision-making instruction is used to indicate whether a corresponding unmanned aerial vehicle server provides to the terminal the service corresponding to the task request. Upon receiving the decision-making instruction sent by each unmanned aerial vehicle server, the terminal selects from among the unmanned aerial vehicle servers only one server capable of providing thereto the service corresponding to the task request to perform interaction, thereby avoiding the situation in the prior art in which a task request sent by a terminal in an overlapping coverage area is served by a plurality of unmanned aerial vehicle servers. The embodiments of the present application improve resource utilization.

### BRIEF DESCRIPTION OF THE DRAWINGS

FIG. 1 is a diagram of an implementation environment of a service decision method in an embodiment;

FIG. 2 is a schematic flowchart of a service decision method in an embodiment;

FIG. 3 is a schematic diagram of overlapping coverage of unmanned aerial vehicle servers and terminals in another embodiment;

FIG. 4 is a schematic flowchart of step 202 in another embodiment;

FIG. 5 is a schematic flowchart of iteratively training a decision network in a target training slot according to another embodiment;

FIG. 6 is a schematic flowchart of storing empirical values corresponding to an iteration process in an experience pool after step 502 in another embodiment;

FIG. 7 is a schematic flowchart of adjusting a network parameter of an evaluation network in another embodiment;

FIG. 8 is a schematic overall flowchart of performing training to obtain a target decision network in another embodiment;

FIG. 9 is a schematic flowchart of a service decision method applied to a terminal in an embodiment;

FIG. 10 is a structural block diagram of a service decision device applied to a target unmanned aerial vehicle server in an embodiment;

FIG. 11 is a structural block diagram of a service decision device applied to a terminal in another embodiment;

FIG. 12 is an internal structural diagram of a computer device in an embodiment; and

FIG. 13 is an internal structural diagram of a computer device in another embodiment.

### DETAILED DESCRIPTION OF THE INVENTION

In order to make the objectives, technical solutions, and advantages of the present application clearer, the present application is further described in detail below with reference to the accompanying drawings and embodiments. It should be understood that the specific embodiments described herein are only used to explain the present application and are not intended to limit the present application.

With the development of computer technology, when people use application programs such as video surveillance, autonomous driving, and automated games, more and more computing resources or bandwidth is needed in order to satisfy computing requirements. Thus, mobile edge computing (MEC) has emerged. That is, when a user needs to perform computing for a certain task having high resource requirements, the task may be offloaded to an MEC server, thereby reducing the computing load on a user terminal, and delay and energy consumption caused by task execution.

Unmanned aerial vehicles (UAV), or drones, have line-of-sight communication capabilities and can be flexibly deployed, so that in a remote area, typically, an unmanned aerial vehicle server having an MEC function provides a mobile edge computing service for a user in the area, thereby enlarging the range of a coverage area in which the service can be received. However, in an actual application scenario, when a plurality of unmanned aerial vehicle servers provide services in the same area, coverage areas of the unmanned aerial vehicle servers overlap. When a user terminal in an overlapping coverage area sends a task request, a situation will occur in which a plurality of unmanned aerial vehicle servers respond to the task request of the user, decreasing resource utilization.

In view of this, embodiments of the present application provide a service decision method. A task request sent by a terminal is received, the task request including a terminal identifier, terminal location information and task information of the terminal, and then if it is determined, on the basis of the terminal location information, that the terminal is currently in an overlapping coverage area, a target decision-making instruction is generated according to the task request and a target decision network, and is sent to the terminal according to the terminal identifier, wherein the target decision-making instruction is used to indicate whether a target unmanned aerial vehicle server provides to the terminal a service corresponding to the task request, and the target decision-making instruction is used by the terminal to select, according to the target decision-making instruction and a decision-making instruction sent by another unmanned aerial vehicle server, one server from among the target unmanned aerial vehicle server and the other unmanned aerial vehicle server to provide the service. In this way, upon receiving the task request of the terminal, each unmanned aerial vehicle server (including the target unmanned aerial vehicle server and the other unmanned aerial vehicle server) corresponding to the overlapping coverage area does not directly provide to the terminal the service corresponding to the task request, but generates the decision-making instruction on the basis of the trained target decision network. The decision-making instruction is used to indicate whether the corresponding unmanned aerial vehicle server provides to the terminal the service corresponding to the task request. Upon receiving the decision-making instruction sent by each unmanned aerial vehicle server, the terminal selects from among the unmanned aerial vehicle servers only one server capable of providing thereto the service corresponding to the task request to perform interaction, thereby avoiding the situation in the prior art in which a task request sent by a terminal in an overlapping coverage area is served by a plurality of unmanned aerial vehicle servers. The embodiments of the present application improve resource utilization.

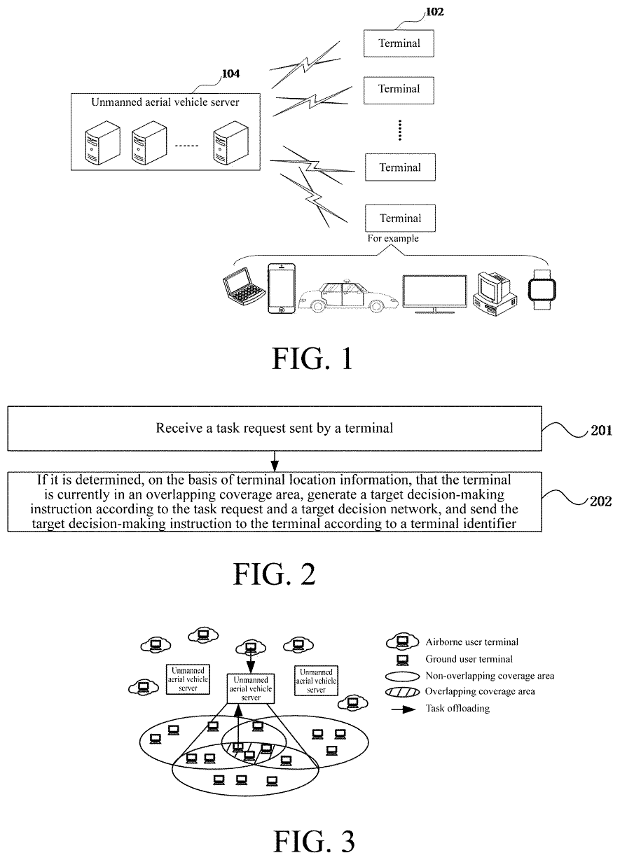

The service decision method provided in the embodiments of the present application can be applied in an implementation environment as shown in FIG. 1. A terminal 102 communicates with a plurality of unmanned aerial vehicle servers 104 via a network. The number of terminals 102 is at least one. Each terminal 102 is in an overlapping coverage area of the plurality of unmanned aerial vehicle servers 104. The terminals 102 may be, but are not limited to, various personal computers, notebook computers, smart phones, tablet computers, Internet of Things devices, and portable wearable devices. Internet of Things devices may be smart speakers, smart televisions, smart air conditioners, smart vehicle-mounted devices, unmanned aerial vehicles, etc. Portable wearable devices may be smart watches, smart bracelets, headsets, etc. Each unmanned aerial vehicle server 104 has a mobile edge computing function, and there are a plurality of unmanned aerial vehicle servers 104 having overlapping coverage areas, which can be implemented using an independent server or a server cluster formed by a plurality of servers.

In one embodiment, as shown in FIG. 2, a service decision method is provided. Description is provided by using an example in which the method is applied to one unmanned aerial vehicle server 104 in FIG. 1. Hereinafter, for ease of description, the unmanned aerial vehicle server 104 is referred to as a target unmanned aerial vehicle server, and the target unmanned aerial vehicle server may be any unmanned aerial vehicle server 104 among the plurality of unmanned aerial vehicle servers 104 shown in FIG. 1. The method includes the following steps:

Step 201, receiving a task request sent by a terminal.

In the embodiments of the present application, an overlapping coverage area is present between the target unmanned aerial vehicle server and another unmanned aerial vehicle server. As shown in FIG. 3, when a plurality of unmanned aerial vehicle servers provide task services in an area, an overlapping coverage area is present between the unmanned aerial vehicle servers. Terminals (including airborne user terminals and ground user terminals) in the overlapping coverage area are associated with the plurality of unmanned aerial vehicle servers, so that when a certain terminal in the overlapping coverage area needs to perform task offloading, the plurality of unmanned aerial vehicle servers associated therewith receive a task request sent by the terminal.

The task request includes a terminal identifier, terminal location information and task information of the terminal. The terminal location information may optionally be latitude and longitude information of the terminal. Optionally, a three-dimensional coordinate system is established for the overlapping coverage area, and the terminal location information is coordinates of the terminal in the three-dimensional coordinate system. The task information is used to represent multi-dimensional information of a task of the terminal for which a task service needs to be currently performed, and includes, but is not limited to, a data size, computational intensity, a maximum allowable delay, etc., of the task. The computational intensity is computing resources required when the target unmanned aerial vehicle server executes a 1-bit task. Here, content included in the task information is not limited.

Upon receiving the task request, the target unmanned aerial vehicle server may determine according to the terminal identifier the terminal to which the task service needs to be provided, may determine the location of the terminal according to the terminal location information, and may determine resources required for the task according to the task information.

For a method used by the target unmanned aerial vehicle server to receive the task request sent by the terminal, optionally, the target unmanned aerial vehicle server receives, in real time, the task request sent by the terminal. Optionally, the target unmanned aerial vehicle server first acquires the quantity of idle resources, for example, idle bandwidth, idle computing resources, etc. When both the bandwidth and the computing resources of the target unmanned aerial vehicle server are occupied, the target unmanned aerial vehicle server does not receive a task request sent by any terminal. When the target unmanned aerial vehicle server has idle bandwidth and idle computing resources, the target unmanned aerial vehicle server receives the task request sent by the terminal. Here, the method used by the target unmanned aerial vehicle server to receive the task request sent by the terminal is not limited.

Step 202, if it is determined, on the basis of the terminal location information, that the terminal is currently in the overlapping coverage area, generating a target decision-making instruction according to the task request and a target decision network, and sending the target decision-making instruction to the terminal according to the terminal identifier.

As shown in FIG. 3, the coverage area range of the target unmanned aerial vehicle server includes an overlapping coverage area and a non-overlapping coverage area.

In one possible embodiment, the target unmanned aerial vehicle server needs to first determine the location information of the terminal, and if the terminal location information is in the overlapping coverage area, the target unmanned aerial vehicle server then generates the target decision-making instruction according to the task request and the target decision network.

The target decision network is a pre-trained neural network, and is used to perform analysis according to the task request, so as to obtain the target decision-making instruction used to indicate whether the target unmanned aerial vehicle server provides to the terminal a service corresponding to the task request.

In the embodiments of the present application, the target decision network may be obtained by performing training by uniting the unmanned aerial vehicle servers corresponding to the overlapping coverage area, and during the training, each unmanned aerial vehicle server can be caused, via a corresponding constraint condition, to sufficiently learn that only one unmanned aerial vehicle server provides the service after the task request sent by the terminal in the overlapping coverage area is received.

For content included in the constraint condition when the target decision-making instruction is generated, for example, idle computing resources of the target unmanned aerial vehicle server are greater than computing resources necessary for the task corresponding to the task request. For example, idle bandwidth resources of the target unmanned aerial vehicle server are greater than bandwidth resources necessary for the task corresponding to the task request. For example, when the target unmanned aerial vehicle server executes the task corresponding to the task request, an execution delay is less than the allowable delay of the task. Here, content included in the constraint condition is not limited.

In this way, in an actual service decision-making process, after the target unmanned aerial vehicle server obtains the target decision-making instruction according to the task request and the target decision network, it can determine whether to provide the task service to the terminal corresponding to the task request. Optionally, when the target unmanned aerial vehicle server determines, according to the task request, that the available resources satisfy the constraint condition, the generated target decision-making instruction indicates that the target unmanned aerial vehicle server provides the service to the terminal. Optionally, when the target unmanned aerial vehicle server determines, according to the task request, that the available resources do not satisfy the constraint condition, the generated target decision-making instruction indicates that the target unmanned aerial vehicle server does not provide the service to the terminal.

For the task request sent by the terminal in the overlapping coverage area, the decision-making instruction of only one unmanned aerial vehicle server among the unmanned aerial vehicle servers (i.e., including the target unmanned aerial vehicle server and the other unmanned aerial vehicle servers) corresponding to the overlapping coverage area is to provide to the terminal the service corresponding to the task request, and all of the decision-making instructions of the other unmanned aerial vehicle servers are to prohibit the service corresponding to the task request from being provided to the terminal.

The target unmanned aerial vehicle server generates the target decision-making instruction according to the task request and the target decision network. The target unmanned aerial vehicle server sends the target decision-making instruction to the corresponding terminal according to a task identifier included in the task request. The target decision-making instruction is used by the terminal to select, according to the target decision-making instruction and a decision-making instruction sent by the other unmanned aerial vehicle server, one server from among the target unmanned aerial vehicle server and the other unmanned aerial vehicle server to provide the service.

Upon receiving the decision-making instruction sent by each unmanned aerial vehicle server corresponding to the overlapping coverage area, the terminal analyzes each decision-making instruction, and thus can determine the server capable of providing thereto the service corresponding to the task request. The terminal performs service interaction with the server to acquire the service. For example, the terminal may upload task data to the server.

In another possible embodiment, the target unmanned aerial vehicle server determines, according to the terminal location information included in the task request, that the location of the terminal is not in the overlapping coverage area, and in this case, only the target unmanned aerial vehicle server is associated with the terminal. In this case, the target unmanned aerial vehicle server does not need to perform decision determination, and directly responds to the task request sent by the terminal.

In the above service decision method, the task request sent by the terminal is received, the task request including the terminal identifier, terminal location information and task information of the terminal, and then if it is determined, on the basis of the terminal location information, that the terminal is currently in the overlapping coverage area, the target decision-making instruction is generated according to the task request and the target decision network, and is sent to the terminal according to the terminal identifier, the target decision-making instruction being used to indicate whether the target unmanned aerial vehicle server provides to the terminal a service corresponding to the task request, and the target decision-making instruction being used by the terminal to select, according to the target decision-making instruction and the decision-making instruction sent by the other unmanned aerial vehicle server, one server from among the target unmanned aerial vehicle server and the other unmanned aerial vehicle server to provide the service. In this way, upon receiving the task request from the terminal, the target unmanned aerial vehicle server first generates the target decision-making instruction on the basis of the trained target decision network, and then determines, according to the target decision-making instruction, whether to provide the corresponding service to the terminal, instead of directly performing a task response to the terminal that sends the task request, as in the prior art, thereby avoiding the situation in which a task request sent by a terminal in an overlapping coverage area is served by a plurality of unmanned aerial vehicle servers, and improving resource utilization.

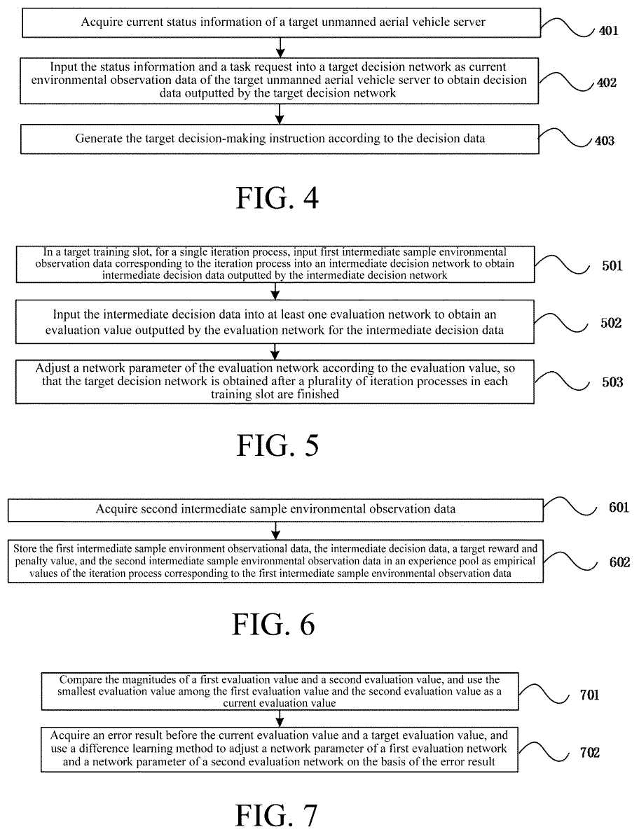

In one embodiment, on the basis of the embodiment shown in FIG. 2, referring to FIG. 4, the embodiments of the present application relate to the process of generating a target decision-making instruction according to a task request and a target decision network. As shown in FIG. 4, step 202 includes step 401 to step 403.

Step 401, acquiring current status information of the target unmanned aerial vehicle server.

An area covered by the target unmanned aerial vehicle server includes an overlapping coverage area and a non-overlapping coverage area, and for a terminal in the non-overlapping coverage area, the target unmanned aerial vehicle server directly responds to a task request sent thereby, so that when the target unmanned aerial vehicle server acquires the task request sent by the terminal in the overlapping coverage area, internal resources thereof may be occupied, and thus the target unmanned aerial vehicle server needs to acquire the current status information.

In a possible embodiment, the status information can reflect information about current occupation of the resources of the target unmanned aerial vehicle server. Upon acquiring the task request sent by the terminal, the target unmanned aerial vehicle server needs to determine, according to the current status information of the target unmanned aerial vehicle server, whether the service can be provided to the terminal. In a possible embodiment, the status information includes server location information of the target unmanned aerial vehicle server, currently available resource information of the target unmanned aerial vehicle server, currently available bandwidth information of the target unmanned aerial vehicle server, and the number of covered users corresponding to the target unmanned aerial vehicle server and the overlapping coverage area. For how to acquire the status information, for example, for determination of the currently available bandwidth resources of the target unmanned aerial vehicle server, the target unmanned aerial vehicle server acquires the maximum bandwidth resources, then acquires the currently occupied maximum bandwidth resources, and determines the currently available bandwidth resources by subtracting the occupied maximum bandwidth resources from the maximum bandwidth resources. For example, for determination of currently available computing resources of the target unmanned aerial vehicle server, the target unmanned aerial vehicle server acquires currently idle computing resources, i.e., the currently available computing resources. Here, the method for acquiring the status information is not limited.

Step 402, inputting the status information and the task request into the target decision network as current environmental observation data of the target unmanned aerial vehicle server, to obtain decision data outputted by the target decision network.

Task requests included in the current environmental observation data are task requests sent by terminals in the overlapping coverage area, the number of which is determined according to the number of terminals in the overlapping coverage area, and the current environmental observation data includes all task requests received by the current target unmanned aerial vehicle server.

After acquiring the status information and the task request sent by the terminal in the overlapping coverage area, the target unmanned aerial vehicle server inputs the status information and the task request into the target decision network as current environmental observation data. The target decision network outputs the decision data for the current environmental observation data. The decision data is used to represent response decisions of the target unmanned aerial vehicle server for all of the task requests currently received. The decision data includes action decision information of the target unmanned aerial vehicle server for the task request, computing resources and bandwidth allocated by the target unmanned aerial vehicle server for the task request, and an expected execution delay.

The action decision information is used to represent whether the target unmanned aerial vehicle server is to provide the service to the terminal corresponding to the task request. The computing resources and bandwidth allocated by the target unmanned aerial vehicle server for the task request and the expected execution delay are all determined on the basis of the task information included in the task request. The expected execution delay is a delay that may be required when the target unmanned aerial vehicle server executes the task corresponding to the task request.

An exemplary description of how to determine the computing resources and bandwidth allocated by the target unmanned aerial vehicle server for the task request and the expected execution delay is provided below:

### 1) For a Determination Process of the Allocated Computing Resources:

For the target unmanned aerial vehicle server, in the case of a slot t, the maximum available computing resources thereof are acquired as Fₘₐₓ(t), and then the currently occupied computing resources thereof are acquired as f₁(t), so that a calculation formula for the computing resources f(t) that can be allocated for the task request by the target unmanned aerial vehicle server is:

$$f ( t ) = {F}_{max} ( t ) - {f}_{1} ( t ) \qquad ( 1 )$$

### 2) For a Determination Process of the Allocated Bandwidth:

For the target unmanned aerial vehicle server, in the case of a slot t, the maximum available computing resources thereof are acquired as Bₘₐₓ(t), and then the currently occupied computing resources thereof are acquired as b₁(t), so that a calculation formula for the computing resources b(t) that can be allocated for the task request by the target unmanned aerial vehicle server is:

$$b ( t ) = {B}_{max} ( t ) - {b}_{1} ( t ) \qquad ( 2 )$$

### 3) For a Determination Process of the Expected Execution Delay:

When the target unmanned aerial vehicle server determines to provide the service for the terminal corresponding to the task request, the overall execution delay is divided into three parts: an uplink transmission delay, a computation delay, and a downlink transmission delay. For the downlink transmission delay, after the target unmanned aerial vehicle server determines to provide the service to the terminal corresponding to the task request, the scale of downlink task data obtained after the service is usually small, and the downlink transmission rate is usually high; therefore, the downlink transmission delay can be ignored, and here, only the uplink transmission delay and the computation delay are calculated when determining the expected execution delay.

### A. Determination of the Uplink Transmission Delay.

According to the task request, the target unmanned aerial vehicle server can determine the terminal location information. A three-dimensional coordinate system is provided in the overlapping coverage area. The terminal location information may be coordinates (x, y, and z), and the target unmanned aerial vehicle server can determine the location coordinates (x₁, y₁, H) of the target unmanned aerial vehicle, so that a calculation formula for a path elevation angle θ of line-of-sight link transmission between the terminal and the target unmanned aerial vehicle server is as follows:

$$θ = 180 / πarcsin ( H / d ) \qquad ( 3 )$$

where d is the distance between the target unmanned aerial vehicle server and the terminal.

The uplink transmission delay is determined according to the allocated bandwidth and path loss at the time of uploading, and the terminal in the overlapping coverage area may be a ground user terminal or an airborne user terminal. For the ground user terminal, when the target unmanned aerial vehicle server receives task-related data uploaded by the terminal, transmission is divided into line-of-sight link transmission (LoS (and non-line-of-sight link transmission (NLoS). For the airborne user terminal, when the target unmanned aerial vehicle server receives task-related data uploaded by the terminal, only line-of-sight link transmission (LoS) is included.

a. For Calculation of Upload Path Loss of the Ground User Terminal:

The probability of performing line-of-sight link transmission between the target unmanned aerial vehicle server and the terminal is:

$${P}_{Los} = \frac{1}{1 + a exp ( - b ( θ - a ) )} \qquad ( 4 )$$

where a and b are environment-related constants.

A formula for calculating the probability of non-line-of-sight link transmission according to the probability of line-of-sight link transmission is:

$${P}_{NLoS} = 1 {P}_{L o S} \qquad ( 5 )$$

A calculation formula for average path loss h_{Los} resulting from the line-of-sight link transmission is:

$${h}_{Los} = 20 log ( 4 π {f}_{c} d / c ) + {η}_{LoS} \qquad ( 6 )$$

A calculation formula for average path loss h_{NLos} resulting from the non-line-of-sight link transmission is:

$${h}_{NLos} = 20 log ( 4 π {f}_{c} d / c ) + {η}_{NLoS} \qquad ( 7 )$$

where f_{c} is a carrier frequency, c is the speed of light, and η_{Los} and η_{NLos} are shadow fading factors of the LoS and NLOS links, respectively.

Therefore, the upload path loss g between the target unmanned aerial vehicle server and the ground user terminal is:

$$g = {P}_{Los} \times {b}_{Los} + {P}_{NLos} \times {h}_{NLos} \qquad ( 8 )$$

b. For Calculation of the Upload Path Loss of the Airborne User Terminal:

$$g = 20 log ( 4 π {f}_{c} d / c ) + {η}_{LoS} \qquad ( 9 )$$

c. The Uplink Transmission Delay is Determined According to the Upload Path Loss:
first, the average rate r of uplink transmission is calculated as:

$$r = b ( t ) {log}_{2} ( 1 + p \times g / {N}_{0} ) \qquad ( 10 )$$

where p is the transmission rate of the terminal, and N₀ is the power of white Gaussian noise.

Therefore, a calculation formula for the uplink transmission delay τₜᵣₐₙₛ(t) is:

$${τ}_{trans} ( t ) = D ( t ) / r \qquad ( 11 )$$

where D (t) is the size of the task data received by the target unmanned aerial vehicle server.

### B. Determination of the Computation Delay:

The computation delay τ_{com}(t) is determined on the basis of the currently available computing resources f(t) of the target unmanned aerial vehicle server, and a calculation formula is as follows:

$${T}_{com} ( t ) = D ( t ) \times M / f ( t ) \qquad ( 12 )$$

where M is the computation intensity corresponding to the task request.

In summary, it can be determined that the expected execution delay τ(t) is the sum of the uplink transmission delay and the computation delay:

$$τ ( t ) = {τ}_{trans} ( t ) + {τ}_{com} ( t ) \qquad ( 13 )$$

Step 403, generating the target decision-making instruction according to the decision data.

Upon acquiring the decision data on the basis of the target decision network and the current environmental observation data, the target unmanned aerial vehicle server can determine whether to provide the service to the terminal corresponding to the task request. In this case, the target decision-making instruction is generated according to the decision data. The target decision-making instruction includes, but is not limited to, an identifier and action decision information of the target unmanned aerial vehicle server, etc.

In this way, in the above embodiment, the target unmanned aerial vehicle server obtains the decision data on the basis of the target decision network and the current environmental observation data, so as to determine whether to provide the service to the terminal corresponding to the task request, and generates the target decision-making instruction on the basis of the decision data to indicate to the terminal whether the service is to be provided, so that the terminal can perform screening on the servers, thereby avoiding the situation in the prior art in which a plurality of servers, after receiving a task request sent by a terminal, respond directly and provide a service to the server, and improving resource utilization.

In one embodiment, on the basis of the embodiment shown in FIG. 2, the embodiments of the present application relate to a case in which the target decision-making instruction indicates that the target unmanned aerial vehicle server provides the service to the terminal, and the service decision method further includes: receiving task data sent by the terminal on the basis of the target decision-making instruction, and performing task processing on the task data according to the target decision-making instruction, so as to provide to the terminal the service corresponding to the task request.

After the target unmanned aerial vehicle server sends the target decision-making instruction to the terminal corresponding to the task request, the terminal determines, according to the target decision-making instruction, that the target unmanned aerial vehicle server provides the service thereto. In this case, the terminal uploads the task data corresponding to the task request, and the target unmanned aerial vehicle server can provide the corresponding service to the task according to the decision data corresponding to the target decision-making instruction, for example, allocating computing resources, bandwidth resources, etc.

Thus, in the above embodiment, how the target unmanned aerial vehicle server executes the target decision-making instruction is explained.

In one embodiment, on the basis of the embodiment shown in FIG. 4, the embodiments of the present application relate to the process of training a neural network to obtain the target decision network. The process includes: in a plurality of training slots, iteratively training an initial decision network on the basis of initial sample environmental observation data corresponding to each training slot so as to obtain the target decision network.

The initial decision network is an untrained decision network. In a possible embodiment, a plurality of unmanned aerial vehicle servers related to the overlapping coverage area cooperatively train the initial decision network. For the target unmanned aerial vehicle server, in a possible embodiment, the number of rounds of training slots is preset. The target unmanned aerial vehicle server iteratively trains the initial decision network on the basis of initial sample environmental observation data corresponding to each round of training slots in the plurality of rounds of training slots. Each round of training slots includes a plurality of iterative training processes.

The initial sample environmental observation data includes a sample task request and sample status information. The initial sample environmental observation data is randomly generated, and the number of sample task requests therein is at least one. Each sample task request corresponds to one terminal in the overlapping coverage area. The sample status information includes at least sample server location information, sample currently available resource information and sample currently available bandwidth information of the target unmanned aerial vehicle server, and the number of covered terminals corresponding to the overlapping coverage area. The available resource information and the available bandwidth information therein are determined immediately. The determination process is exemplarily explained below.

### 4) Determination of the Sample Currently Available Resource Information.

The target unmanned aerial vehicle server first acquires maximum available resource information as Fₘₐₓ(t), and then determines sample occupied resource information f₁(t) of the target unmanned aerial vehicle server. Resource information allocated by the target unmanned aerial vehicle server to the user terminal in the non-overlapping coverage area is modeled as independently identically distributed, and a parameter is a Poisson process of ∂. A calculation formula for f₁(t) is:

$${f}_{1} ( t ) = P ( ϑ ) {f}_{un} \qquad ( 14 )$$

where fᵤₙ is a unit computing resource.

The sample currently available resource information fₛₐₘₚₗₑ(t) can be obtained by subtracting the sample occupied resource information from the maximum available resource information:

$${f}_{sample} ( t ) = {F}_{max} ( t ) - {f}_{1} ( t ) \qquad ( 15 )$$

### 5) Determination of the Sample Currently Available Bandwidth.

The target unmanned aerial vehicle server first acquires maximum available bandwidth information as Bₘₐₓ(t), and then determines sample occupied bandwidth information b₁(t) of the target unmanned aerial vehicle server. Bandwidth information allocated by the target unmanned aerial vehicle server to the user terminal in the non-overlapping coverage area is modeled as independently identically distributed, and a parameter is a Poisson process of ζ. A calculation formula for b₁(t) is:

$${b}_{1} ( t ) = P ( ζ ) {b}_{un} \qquad ( 16 )$$

where bᵤₙ is a unit bandwidth resource.

The sample currently available bandwidth information bₛₐₘₚₗₑ(t) can be obtained by subtracting the sample occupied bandwidth information from the maximum available bandwidth information:

$${b}_{sample} ( t ) = {B}_{max} ( t ) - {b}_{1} ( t ) \qquad ( 17 )$$

Thus, in the above embodiment, the target unmanned aerial vehicle server iteratively trains the initial decision network on the basis of the initial sample environmental observation data corresponding to each round of training slots, and a target decision network having good performance is obtained after the plurality of rounds of training slots.

In one embodiment, the embodiments of the present application relate to the process of iteratively training the initial decision network on the basis of the initial sample environmental observation data corresponding to each training slot so as to obtain the target decision network. As shown in FIG. 5, the process includes step 501 to step 503.

Step 501, in a target training slot, for a single iteration process, inputting first intermediate sample environmental observation data corresponding to the iteration process into an intermediate decision network, to obtain intermediate decision data outputted by the intermediate decision network.

One round of training slots includes a plurality of iteration processes. For the current target training slot, for a single iteration process therein, the target unmanned aerial vehicle server inputs the first intermediate sample environmental observation data corresponding to the iteration process into the intermediate decision network, and the intermediate decision network outputs the corresponding intermediate decision data on the basis of the first intermediate sample environmental observation data.

Step 502, inputting the intermediate decision data into at least one evaluation network to obtain an evaluation value outputted by the evaluation network for the intermediate decision data.

The evaluation network is a neural network for evaluating decision data. After inputting the decision data into the evaluation network, the target unmanned aerial vehicle server obtains the evaluation value corresponding to the decision data. The evaluation value is determined on the basis of a target reward and penalty value for the intermediate decision data. The target reward and penalty value is determined by the target unmanned aerial vehicle server by performing determination on the intermediate decision data on the basis of a plurality of reward and penalty constraint conditions. In a possible embodiment, the target unmanned aerial vehicle server inputs the intermediate decision data into the at least one evaluation network to obtain the reward and penalty values corresponding to the plurality of reward and penalty constraint conditions, wherein the reward and penalty constraint conditions include at least one of a restrictive condition on the number of users served by the target unmanned aerial vehicle server, a restrictive condition on computing resource allocation by the target unmanned aerial vehicle server, a restrictive condition on bandwidth allocation by the target unmanned aerial vehicle server, a restrictive condition on a task execution delay of the target unmanned aerial vehicle server, and a restrictive condition on a delay corresponding to each training slot.

How the target unmanned aerial vehicle server performs the determination on the intermediate decision data on the basis of the plurality of reward and penalty constraint conditions to acquire the corresponding target reward and penalty value is exemplarily explained here.

6) The restrictive condition on the number of users served by the target unmanned aerial vehicle server.

In a possible embodiment, the associated unmanned aerial vehicle servers in the overlapping coverage area can provide a server for only one terminal at the same moment, and one terminal can receive a service from only one unmanned aerial vehicle server. When there is an error in the one-to-one relationship, and when one terminal is responded to by a plurality of unmanned aerial vehicle servers, it indicates that a decision error has occurred in the responding unmanned aerial vehicle servers. Alternatively, when one terminal is not responded to by any unmanned aerial vehicle server, it indicates that a decision error has occurred in the plurality of unmanned aerial vehicle servers associated with the overlapping coverage area.

On the basis of the above reward and penalty constraint condition, for the intermediate decision data outputted by the target unmanned aerial vehicle server according to the intermediate decision network, it is required to first determine the total number of terminals that the target unmanned aerial vehicle server has responded to for a plurality of received task requests. Then, the number of unmanned aerial vehicle servers serving one terminal is determined according to intermediate decision data outputted by other unmanned aerial vehicle servers that cooperatively perform training.

In a possible embodiment, it is assumed that a set of user terminals in the overlapping coverage area is J={1, 2, . . . , J}, and the number of unmanned aerial vehicle servers associated with the overlapping coverage area is M. A set of the unmanned aerial vehicle servers is M={1, 2, . . . , M}. At a certain time, corresponding information about the target unmanned aerial vehicle server m for the terminal j in the intermediate decision data is represented by a binary variable aₘⱼ(t). When aₘⱼ(t)=1, it represents that the target unmanned aerial vehicle server m serves the j-th terminal. When aₘⱼ(t)=0, it represents that the target unmanned aerial vehicle server m does not serve the j-th terminal. Thus, the constraint relationship corresponding to the restrictive condition on the number of terminals served by the target unmanned aerial vehicle server m is expressed by the following formula:

$${\sum }_{m = 1}^{M} {α}_{mj} ( t ) = 0 \qquad ( 18 )$$

Formula (18) indicates that the terminal j is not responded to by any unmanned aerial vehicle server.

$${α}_{mj} ( t ) = 1 ⋂ {\sum }_{i = 1 , i \neq m}^{M} {α}_{mj} ( t ) > 0 \qquad ( 19 )$$

Formula (19) indicates that the terminal j is responded to by the target unmanned aerial vehicle server m, and is also responded to by another unmanned aerial vehicle server. When the intermediate decision data outputted by the plurality of unmanned aerial vehicle servers associated with the overlapping coverage area satisfy the two formulas, i.e., formula (18) or (19), it indicates that a decision error has occurred in the corresponding unmanned aerial vehicle server, and a corresponding penalty value is obtained.

7) The restrictive condition on bandwidth allocation by the target unmanned aerial vehicle server.

In a possible embodiment, the relevant constraint condition is that a decision error occurs when the computing resources allocated by the target unmanned aerial vehicle server to the terminal are greater than the available resources of the target unmanned aerial vehicle server. According to formula (1) to formula (19), the constraint condition is expressed as:

$${\sum }_{j = 1}^{J} {b}_{mj} ( t ) {α}_{mj} ( t ) > {b}_{m} ( t ) \qquad ( 20 )$$

where bₘⱼ(t) represents the computing resources allocated by the target unmanned aerial vehicle server to the terminal j, and bₘ(t) represents the currently available computing resources of the target unmanned aerial vehicle server. Formula (20) is used to indicate that the computing resources allocated by the target unmanned aerial vehicle server to the terminals are greater than the currently allocatable computing resources. When the intermediate decision data of the target unmanned aerial vehicle server satisfies formula (20), it indicates that a decision error has occurred in the target unmanned aerial vehicle server, and a corresponding penalty value is obtained.

8) The restrictive condition on computing resource allocation by the target unmanned aerial vehicle server.

In a possible embodiment, the relevant constraint condition is configured to be that when the bandwidth allocated by the target unmanned aerial vehicle server to the terminal is greater than the available bandwidth of the target unmanned aerial vehicle server, it indicates that a decision error has occurred in the target unmanned aerial vehicle server. According to formula (1) to formula (20), the constraint condition is expressed as:

$${\sum }_{j = 1}^{J} {f}_{mj} ( t ) {α}_{mj} ( t ) > {f}_{m} ( t ) \qquad ( 21 )$$

where fₘⱼ (t) represents the bandwidth allocated by the target unmanned aerial vehicle server to the terminal j, and fₘ(t) represents the currently available bandwidth of the target unmanned aerial vehicle server. Formula (21) is used to indicate that the bandwidth allocated by the target unmanned aerial vehicle server to the terminals is greater than the currently allocatable bandwidth. When the intermediate decision data of the target unmanned aerial vehicle server satisfies formula (21), it indicates that a decision error has occurred on the target unmanned aerial vehicle server, and a corresponding penalty value is obtained.

9) The restrictive condition on the task execution delay of the target unmanned aerial vehicle server.

In a possible embodiment, the relevant constraint condition is configured such that when the execution delay of the task of the terminal j executed by the target unmanned aerial vehicle server m is less than the maximum allowable delay of the task, it indicates that the service of the target unmanned aerial vehicle server m is successful, and a corresponding reward value is acquired; otherwise, the service fails, and a corresponding penalty value is acquired. When the execution delay is less than the maximum allowable delay of the task, the shorter the execution delay, the greater the reward value; when the execution delay is greater than the maximum allowable delay of the task, the longer the execution delay, the greater the penalty value.

In a possible embodiment, a calculation function for the reward and penalty value r₁(t) corresponding to the restrictive condition of the task execution delay of the target unmanned aerial vehicle server m is as follows:

$${r}_{1} ( t ) = \{ \begin{matrix}{log}_{2} ( 0.1 + \frac{{δ}_{j} ( t )}{{τ}_{j} ( t )} ) , & {τ}_{j} ( t ) \leq {δ}_{j} ( t ) \\ {log}_{2} ( \frac{{δ}_{j} ( t )}{{τ}_{j} ( t )} ) , & {τ}_{j} ( t ) > {δ}_{j} ( t )\end{matrix} \qquad ( 22 )$$

where τⱼ(t) represents an expected execution delay of the task corresponding to the terminal j executed by the target unmanned aerial vehicle server, and δⱼ(t) represents the maximum allowable delay of the task corresponding to the terminal j. Formula (22) indicates that when the task is executed by the target unmanned aerial vehicle server m and the execution delay is less than the maximum allowable delay, the reward value is a positive value. In addition, the shorter the execution delay, the greater the reward value. When the execution delay is greater than the maximum allowable delay, the reward value is a negative value. That is, for the penalty value, the longer the execution delay, the greater the penalty value.

In summary, each reward and penalty value corresponding to each reward and penalty constraint condition can be obtained. Then, the target unmanned aerial vehicle server acquires the target reward and penalty value for the intermediate decision data according to each reward and penalty value, and acquires the evaluation value according to the target reward and penalty value.

10) Regarding determination of the target reward and penalty value, in a possible embodiment, different reward factors η are set according to different reward and penalty constraint conditions, and the target reward and penalty value rₘ(t) is represented by the following formula:

$${r}_{m} ( t ) = η ( t ) + {η}_{1} {∧}_{( {\sum }_{m = 1}^{M} {α}_{mj} ( t ) = 0 )} + {η}_{2} {∧}_{( {α}_{mj} ( t ) = 0 ⋂ {\sum }_{i = 1 , i \neq m}^{M} {α}_{mj} ( t ) > 0 )} + {η}_{3} {∧}_{( {\sum }_{j = 1}^{J} {f}_{mj} ( t ) {α}_{mj} ( t ) > {f}_{m} ( t ) )} + {η}_{4} {∧}_{( {\sum }_{j = 1}^{J} {b}_{mj} ( t ) {α}_{mj} ( t ) > {b}_{m} ( t ) )} + {η}_{4} \text{?} \qquad ( 23 )$$

$$\text{?} \text{indicates text missing or illegible when filed}$$

where Λ_{(*)} indicates that Λ_{(*)}=1 if the condition (*) is satisfied, and otherwise the value is 0.

Step 503, adjusting a network parameter of the evaluation network according to the evaluation value, so that the target decision network is obtained after a plurality of iteration processes in each training slot are finished.

In a possible embodiment, for one round of training slots, the target unmanned aerial vehicle server performs iterative training on the initial decision network a plurality of times, and after each training process, adjusts the parameter of the evaluation network according to the evaluation value. After a plurality of times of iterative training, training of one round of training slots is completed, and the final target decision network is acquired.

11) In a possible embodiment, for one round of training slots, after the target unmanned aerial vehicle server satisfies the reward and penalty constraint conditions in each iteration process according to the intermediate decision data outputted by the intermediate decision network, an optimal decision for the current training slot can be determined.

For an optimal policy, that is, the sum of execution delays caused when the plurality of unmanned aerial vehicle servers associated with the overlapping coverage area currently perform task execution for each terminal is the minimum, a specific expression formula is as follows:

$$min \frac{1}{T} {\sum }_{t = 1}^{T} {\sum }_{m = 1}^{M} {\sum }_{j = 1}^{J} {τ}_{mj} ( t ) \qquad ( 24 )$$

where 1-T is one round of training slots, and t is a single iteration of training. For one round of training slots, when the sum of average execution delays of each iterative training process thereof is the minimum value, a plurality of pieces of intermediate decision data obtained in the round of training slots are an optimal decision.

In this way, in the above embodiment, the intermediate decision data outputted by the intermediate decision network of each iteration of training is evaluated by the constantly optimized evaluation network, and a target decision network having good performance is finally obtained after a plurality of rounds of training slots.

In one embodiment, referring to FIG. 6, as involved in the embodiments of the present application, after the intermediate decision data is inputted into at least one evaluation network to obtain an evaluation value outputted by the evaluation network for the intermediate decision data, the method of the embodiment further includes step 601 and step 602 as shown in FIG. 6.

Step 601, acquiring second intermediate sample environmental observation data.

The second intermediate sample environmental observation data is automatically generated according to the environment.

In a possible embodiment, after the target unmanned aerial vehicle server inputs the first sample environmental observation data into the intermediate decision network, the intermediate decision data is outputted. Then, the second intermediate sample environmental observation data is automatically generated according to the current environment.

Step 602, storing the first intermediate sample environmental observation data, the intermediate decision data, the target reward and penalty value, and the second intermediate sample environmental observation data in an experience pool as empirical values of the iteration process corresponding to the first intermediate sample environmental observation data.

The experience pool includes the empirical values corresponding to the target unmanned aerial vehicle server and the other unmanned aerial vehicle server.

Thus, in the above embodiment, the target unmanned aerial vehicle server stores the first intermediate sample environmental observation data of each iteration process, the generated intermediate decision data, the target reward and penalty value, and the second intermediate sample environmental observation data obtained according to the first intermediate sample environmental observation data and the intermediate decision data in the experience pool as empirical values. Finally, the network parameter of the intermediate decision network is adjusted according to the empirical values in the experience pool to obtain the target decision network.

In one embodiment, the embodiments of the present application relate to the process of adjusting the network parameter of the intermediate decision network after step 602. The process includes:

After a plurality of iteration processes in the target training slot are finished, adjusting a network parameter of the intermediate decision network on the basis of the empirical values in the experience pool, so as to obtain the target decision network.

In a possible embodiment, after one round of training slots is finished, the target unmanned aerial vehicle server m performs gradient optimization on the network parameter Pa of the intermediate decision network according to the empirical values in the experience pool and the evaluation value Q corresponding to each empirical value. Exemplarily, a relevant optimization function is:

$${∇}_{m} J ( {ϕ}_{m} ) = {x , 𝒟}_{} [ {∇}_{m} {π}_{{ϕ}_{m}} ( {α}_{m} \vert {o}_{m} ) \times {∇}_{m} Q ] \qquad ( 25 )$$

where x is global status information and is a vector including environmental observation data observed by all unmanned aerial vehicle servers, D is the experience pool, am is action decision information included in the intermediate decision data, and om is the intermediate sample environmental observation data.

Thus, in the above embodiment, the target unmanned aerial vehicle server performs gradient optimization on the network parameter of the intermediate decision network on the basis of the plurality of empirical values and the evaluation value Q, so as to finally obtain the target decision network with good performance.

In one embodiment, referring to FIG. 7, the embodiments of the present application relate to the process of adjusting a network parameter of the evaluation network according to the evaluation value in the case that the evaluation network includes a first evaluation network and a second evaluation network, and the evaluation value includes a first evaluation value outputted by the first evaluation network and a second evaluation value outputted by the second evaluation network. As shown in FIG. 7, the process includes step 801 and step 802.

In a possible embodiment, on the basis of consideration of the multi-agent twin delayed deep deterministic policy gradient algorithm (the MATD3 framework), two evaluation networks, i.e., the first evaluation network and the second evaluation network, are provided in order to prevent the evaluation network from overestimating decision data outputted by the intermediate decision network.

Step 701, comparing magnitudes of the first evaluation value and the second evaluation value, and using the smallest evaluation value of the first evaluation value and the second evaluation value as a current evaluation value.

In a possible embodiment, the target unmanned aerial vehicle server separately inputs the intermediate decision data outputted by the intermediate decision network into the first evaluation network and the second evaluation network, and then the two evaluation networks output the first evaluation value and the second evaluation value, respectively. On the basis of formulas (1) to (25), a formula to acquire the evaluation value Qₘ is as follows:

$${Q}_{m} = {r}_{m} + γ {Q}^{′} \qquad ( 26 )$$

where rₘ is the target reward and penalty value corresponding to this iteration process, γ is a discount factor, and Q′ is the current evaluation value obtained in a next state.

In a possible embodiment, the first evaluation value and the second evaluation value are each obtained via formula (26), and in order to prevent overestimation, the first evaluation value and the second evaluation value are compared to select the smaller evaluation value as the current evaluation value.

Step 702, acquiring an error result before the current evaluation value and a target evaluation value, and adjusting a network parameter of the first evaluation network and a network parameter of the second evaluation network on the basis of the error result by using a difference learning method.

In a possible embodiment, the target evaluation value Q is the evaluation value that is desired to be acquired for this iteration process, and is determined on the basis of the current evaluation value Qₘ, and a calculation process is as follows:

$$Q = {x , 𝒟}_{} [ {r}_{m} + γ {Q}^{′} ] \qquad ( 27 )$$

In a possible embodiment, the network parameter of the first evaluation network and the network parameter of the second evaluation network are adjusted on the basis of the error result using the difference learning method.

For reducing the error result by using temporal difference learning, for example:

$$( {ϕ}_{m} ) = {x , α , x , {x}^{′}}_{} [ {( Q - {Q}_{m} )}^{2} ] \qquad ( 28 )$$

Thus, in the above embodiment, two evaluation networks are provided on the basis of the MATD3 framework, and for each iterative training process, the two evaluation networks evaluate the intermediate decision data outputted by the intermediate decision network, thereby avoiding overestimation of the intermediate decision data.

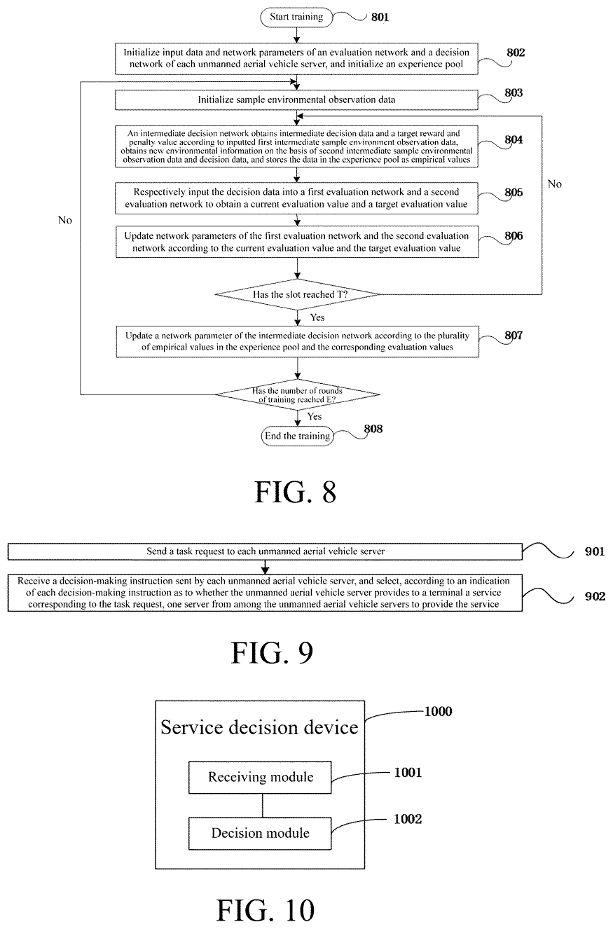

In an embodiment, referring to FIG. 8, the process of the target unmanned aerial vehicle server performing training to obtain the target decision network is exemplarily explained:

Step 801, starting training.

Step 802, initializing input data and parameters of the evaluation network and the target decision network of the plurality of unmanned aerial vehicle servers associated with the overlapping coverage area, and initializing the experience pool.

Step 803, presetting E rounds of training slots, and for one round of training slots, initializing sample environmental observation data of the initial decision network.

Step 804, one round of training slots including a plurality of iteration processes, for a single iteration process, the intermediate decision network obtaining intermediate decision data and a target reward and penalty value according to the inputted first intermediate sample environmental observation data, obtaining new environmental information on the basis of the second intermediate sample environmental observation data and the decision data, and storing the data in the experience pool as empirical values.

Step 805, separately inputting the decision data into the first evaluation network and the second evaluation network, to obtain the current evaluation value and the target evaluation value.

Step 806, updating the network parameters of the first evaluation network and the second evaluation network according to the current evaluation value and the target evaluation value.

Step 807, determining whether one round of training slots has been finished; if not, repeating step 804 to step 806, and if so, updating the network parameter of the intermediate decision network according to the plurality of empirical values in the experience pool and the corresponding evaluation values.

Step 808, determining whether the number of rounds of training slots has reached the preset E; if not, repeating step 903 to step 907, and if so, ending the training, and obtaining the target decision network.

In one embodiment, as shown in FIG. 9, a service decision method is provided. Description is provided by using an example in which the method is applied to the terminal 92 in FIG. 1. The terminal is in an overlapping coverage area of a plurality of unmanned aerial vehicle servers. The method includes the following steps:

Step 901, sending a task request to each unmanned aerial vehicle server. The task request includes a terminal identifier, terminal location information and task information of the terminal.

In a possible embodiment, the terminal acquires task data that needs to be currently executed by the unmanned aerial vehicle server. Corresponding task information is determined according to the task data. The task information includes, but is not limited to, a data size, computation intensity, a maximum allowable delay of a task. Then, the terminal generates the task request according to the terminal identifier, the terminal location information, and the task information, and sends the task request to the plurality of associated unmanned aerial vehicle servers. The task request is used by each unmanned aerial vehicle server to generate a corresponding decision-making instruction.

Step 902, receiving a decision-making instruction sent by each unmanned aerial vehicle server, and selecting, according to an indication of each decision-making instruction as to whether the unmanned aerial vehicle server provides to the task request to the terminal a service corresponding, one server from among the unmanned aerial vehicle servers to provide the service.

In a possible embodiment, only one decision-making instruction among the plurality of decision-making instructions is used to indicate to the terminal that the unmanned aerial vehicle server corresponding thereto can provide the service thereto. Upon receiving the decision-making instruction sent by each unmanned aerial vehicle server, the terminal performs screening to determine the unmanned aerial vehicle server capable of responding to the task request as the target unmanned aerial vehicle server, and sends task data to the target unmanned aerial vehicle server. The decision-making instruction is generated by the unmanned aerial vehicle server according to the task request and a target decision network.

For acquisition of the decision-making instruction, reference may be made to the relevant description of the above embodiment, and details are not described herein again.

Thus, in the above embodiment, the terminal in the overlapping coverage area receives the decision-making instructions generated by the plurality of unmanned aerial vehicle servers, and selects therefrom the unmanned aerial vehicle server capable of responding to the task request so as to upload the task data to execute the task, thereby preventing the terminal from receiving the service provided by a plurality of unmanned aerial vehicle server at the same time.

In one embodiment, an exemplary service decision method is provided. The method can be applied in the implementation environment shown in FIG. 1. The method includes:

Step 1, in a plurality of training slots, iteratively training, by a target unmanned aerial vehicle server, an initial decision network on the basis of initial sample environmental observation data corresponding to each training slot, and in a target training slot, for a single iteration process, inputting first intermediate sample environmental observation data corresponding to the iteration process into an intermediate decision network to obtain intermediate decision data outputted by the intermediate decision network.

Step 2, acquiring, by the target unmanned aerial vehicle server, second intermediate sample environmental observation data, the second intermediate sample environmental observation data being sample environmental observation data of an iteration process following the iteration process corresponding to the first intermediate sample environmental observation data.

Step 3, storing, by the target unmanned aerial vehicle server, the first intermediate sample environmental observation data, the intermediate decision data, the target reward and penalty value, and the second intermediate sample environmental observation data in an experience pool as empirical values of the iteration process corresponding to the first intermediate sample environmental observation data. The experience pool includes the empirical values corresponding to the target unmanned aerial vehicle server and the other unmanned aerial vehicle server.

Step 4, inputting, by the target unmanned aerial vehicle server, the intermediate decision data into at least one evaluation network to obtain reward and penalty values corresponding to a plurality of reward and penalty constraint conditions. The reward and penalty constraint conditions include at least one of a restrictive condition on the number of users served by the target unmanned aerial vehicle server, a restrictive condition on computing resource allocation by the target unmanned aerial vehicle server, a restrictive condition on bandwidth allocation by the target unmanned aerial vehicle server, a restrictive condition on a task execution delay of the target unmanned aerial vehicle server, and a restrictive condition on a delay corresponding to each training slot.

Step 5, acquiring, by the target unmanned aerial vehicle server, the target reward and penalty value for the intermediate decision data according to each reward and penalty value, and acquiring the evaluation value according to the target reward and penalty value. The evaluation network includes a first evaluation network and a second evaluation network, and the evaluation value includes a first evaluation value outputted by the first evaluation network and a second evaluation value outputted by the second evaluation network. The evaluation value is determined on the basis of a target reward and penalty value for the intermediate decision data.

Step 6, comparing, by the target unmanned aerial vehicle server, magnitudes of the first evaluation value and the second evaluation value, and using the smallest evaluation value of the first evaluation value and the second evaluation value as a current evaluation value.

Step 7, acquiring, by the target unmanned aerial vehicle server, an error result before the current evaluation value and a target evaluation value, and adjusting a network parameter of the first evaluation network and a network parameter of the second evaluation network on the basis of the error result by using a difference learning method.

Step 8, after a plurality of iteration processes in the target training slot are finished, adjusting, by the target unmanned aerial vehicle server, the network parameter of the intermediate decision network on the basis of the empirical values in the experience pool to obtain the target decision network. The initial sample environmental observation data includes a sample task request and sample status information.

Step 9, sending, by a terminal, a task request to each unmanned aerial vehicle server.

Step 10, receiving, by the target unmanned aerial vehicle server, the task request sent by the terminal, the task request including a terminal identifier, terminal location information, and task information of the terminal.

Step 11, if it is determined on the basis of the terminal location information that the terminal is currently in an overlapping coverage area, acquiring, by the target unmanned aerial vehicle server, current status information of the target unmanned aerial vehicle server. The status information includes server location information of the target unmanned aerial vehicle server, currently available resource information of the target unmanned aerial vehicle server, currently available bandwidth information of the target unmanned aerial vehicle server, and the number of covered users corresponding to the target unmanned aerial vehicle server and the overlapping coverage area.

Step 12, inputting, by the target unmanned aerial vehicle server, the status information and the task request into the target decision network as current environmental observation data of the target unmanned aerial vehicle server to obtain decision data outputted by the target decision network. The decision data includes action decision information of the target unmanned aerial vehicle server for the task request, computing resources and bandwidth allocated by the target unmanned aerial vehicle server for the task request, and an expected execution delay.

Step 13, generating, by the target unmanned aerial vehicle server, the target decision-making instruction according to the decision data.

Step 14, sending, by the target unmanned aerial vehicle server, the target decision-making instruction to the terminal according to the terminal identifier. The target decision-making instruction is used to indicate whether the target unmanned aerial vehicle server provides to the terminal a service corresponding to the task request, and the target decision-making instruction is used by the terminal to select, according to the target decision-making instruction and a decision-making instruction sent by the other unmanned aerial vehicle server, one server from among the target unmanned aerial vehicle server and the other unmanned aerial vehicle server to provide the service.

Step 15, receiving, by the terminal, a decision-making instruction sent by each unmanned aerial vehicle server, and selecting, according to an indication of each decision-making instruction as to whether the unmanned aerial vehicle server provides to the terminal a service corresponding to the task request, one server from among the unmanned aerial vehicle servers to provide the service, the decision-making instructions being generated by the unmanned aerial vehicle servers according to the task requests and a target decision network.

Step 16, when the target decision-making instruction indicates that the target unmanned aerial vehicle server provides the service to the terminal, receiving, by the target unmanned aerial vehicle server, task data sent by the terminal on the basis of the target decision-making instruction, and performing task processing on the task data according to the target decision-making instruction, so as to provide to the terminal the service corresponding to the task request.

It should be understood that, although the steps in the flowcharts related to the embodiments described above are shown in sequence as indicated by the arrows, the steps are not necessarily performed in sequence in the order indicated by the arrows. Unless explicitly stated otherwise herein, there is no strict order of execution of the steps, and the steps may be executed in other orders. Furthermore, at least a part of steps in the flowcharts related to the embodiments described above may include a plurality of steps or a plurality of stages, and the steps or stages are not necessarily performed at the same time but may be performed at different times. The steps or stages are not necessarily performed sequentially but may be performed in turn or alternately with other steps or at least a part of steps or stages in other steps.

On the basis of the same inventive concept, the embodiments of the present application further provide a service decision device, used to implement the service decision method for the target unmanned aerial vehicle server 104. The implementation solution provided by the device to solve the problem is similar to the implementation solution described in the above method, so that for the specific definition in one or more embodiments of the service decision device provided below, reference may be made to the definition of the service decision method in the above description, and details are not described herein again.

In one embodiment, as shown in FIG. 10, a service decision device 1000 is provided for a target server. An overlapping coverage area is present between the target unmanned aerial vehicle server and another unmanned aerial vehicle server. The device includes: a receiving module 1001 and a decision module 1002, wherein:

The receiving module 1001 is used to receive a task request sent by a terminal, the task request including a terminal identifier, terminal location information, and task information of the terminal;

The decision module 1002 is used to, if it is determined, on the basis of the terminal location information, that the terminal is currently in the overlapping coverage area, generate a target decision-making instruction according to the task request and a target decision network, and send the target decision-making instruction to the terminal according to the terminal identifier. The target decision-making instruction is used to indicate whether the target unmanned aerial vehicle server provides to the terminal a service corresponding to the task request, and the target decision-making instruction is used by the terminal to select, according to the target decision-making instruction and a decision-making instruction sent by the other unmanned aerial vehicle server, one server from among the target unmanned aerial vehicle server and the other unmanned aerial vehicle server to provide the service.

In one embodiment, the decision module 1002 includes: an acquisition unit, used to acquire current status information of the target unmanned aerial vehicle server; a decision unit, used to input the status information and the task request into the target decision network as current environmental observation data of the target unmanned aerial vehicle server to obtain decision data outputted by the target decision network, the decision data including action decision information of the target unmanned aerial vehicle server for the task request, computing resources and bandwidth allocated by the target unmanned aerial vehicle server for the task request, and an expected execution delay; and a generating unit, used to generate the target decision-making instruction according to the decision data.

In one embodiment, the status information includes server location information of the target unmanned aerial vehicle server, currently available resource information of the target unmanned aerial vehicle server, currently available bandwidth information of the target unmanned aerial vehicle server, and the number of covered users corresponding to the target unmanned aerial vehicle server and the overlapping coverage area.

In one embodiment, when the target decision-making instruction indicates that the target unmanned aerial vehicle server provides the service to the terminal, the device further includes: a service module, used to receive task data sent by the terminal on the basis of the target decision-making instruction, and perform task processing on the task data according to the target decision-making instruction, so as to provide to the terminal the service corresponding to the task request.

In one embodiment, the device further includes: a training module, used to, in a plurality of training slots, iteratively train an initial decision network on the basis of initial sample environmental observation data corresponding to each training slot so as to obtain the target decision network, the initial sample environmental observation data including a sample task request and sample status information.

In one embodiment, the training module includes: an iteration unit, used to, in a target training slot, for a single iteration process, input first intermediate sample environmental observation data corresponding to the iteration process into an intermediate decision network to obtain intermediate decision data outputted by the intermediate decision network; an evaluation unit, used to input the intermediate decision data into at least one evaluation network to obtain an evaluation value outputted by the evaluation network for the intermediate decision data, the evaluation value being determined on the basis of a target reward and penalty value for the intermediate decision data; and an adjustment unit, used to adjust a network parameter of the evaluation network according to the evaluation value, so that the target decision network is acquired after a plurality of iteration processes in each training slot are finished.

In one embodiment, the device further includes: a data acquisition module, used to acquire second intermediate sample environmental observation data, the second intermediate sample environmental observation data being sample environmental observation data of an iteration process following the iteration process corresponding to the first intermediate sample environmental observation data; and an empirical value storage module, used to store the first intermediate sample environmental observation data, the intermediate decision data, the target reward and penalty value, and the second intermediate sample environmental observation data in an experience pool as empirical values of the iteration process corresponding to the first intermediate sample environmental observation data. The experience pool includes the empirical values corresponding to the target unmanned aerial vehicle server and the other unmanned aerial vehicle server.

In one embodiment, the device further includes: an adjustment module, used to, after a plurality of iteration processes in the target training slot are finished, adjust the network parameter of the intermediate decision network on the basis of the empirical values in the experience pool to obtain the target decision network.

In one embodiment, the evaluation unit is used to input the intermediate decision data into at least one evaluation network to obtain reward and penalty values corresponding to a plurality of reward and penalty constraint conditions, wherein the reward and penalty constraint conditions include at least one of a restrictive condition on the number of users served by the target unmanned aerial vehicle server, a restrictive condition on computing resource allocation by the target unmanned aerial vehicle server, a restrictive condition on bandwidth allocation by the target unmanned aerial vehicle server, a restrictive condition on a task execution delay of the target unmanned aerial vehicle server, and a restrictive condition on a delay corresponding to each training slot; acquire the target reward and penalty value for the intermediate decision data according to each reward and penalty value, and acquire the evaluation value according to the target reward and penalty value.

In one embodiment, the evaluation network includes a first evaluation network and a second evaluation network, and the evaluation value includes a first evaluation value outputted by the first evaluation network and a second evaluation value outputted by the second evaluation network. The evaluation unit is also used to compare magnitudes of the first evaluation value and the second evaluation value, and use the smallest evaluation value of the first evaluation value and the second evaluation value as a current evaluation value; acquire an error result before the current evaluation value and a target evaluation value, and adjust a network parameter of the first evaluation network and a network parameter of the second evaluation network on the basis of the error result by using a difference learning method.

The embodiments of the present application further provide a service decision device for implementing the above service decision method applied to the terminal 102. The implementation solution provided by the device to solve the problem is similar to the implementation solution described in the above method, so that for the specific definition in one or more embodiments of the article surveillance device provided below, reference may be made to the definition of the article surveillance method in the above description, and details are not described herein again.

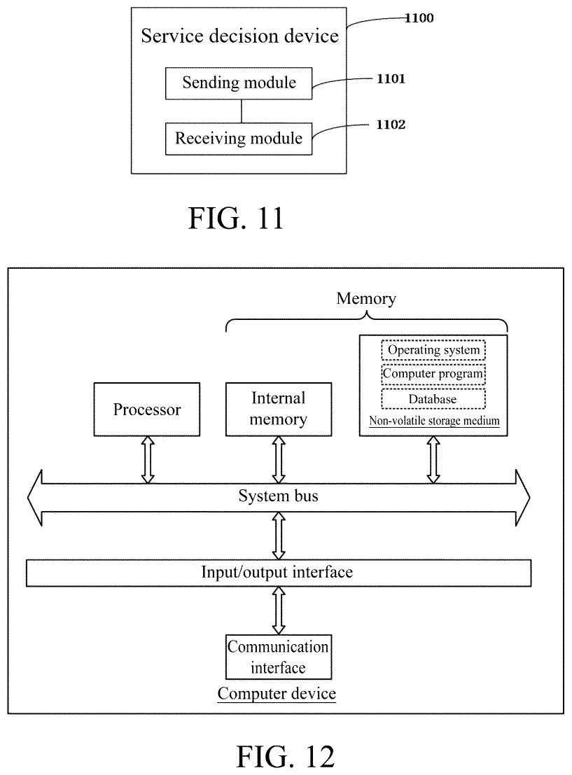

In one embodiment, as shown in FIG. 11, a service decision device 1100 is provided, and is applied to a terminal, the terminal being in an overlapping coverage area of a plurality of unmanned aerial vehicle servers. The device includes: a sending module 1101 and a receiving module 1102, wherein:

The sending module 1101 is used to send a task request to each unmanned aerial vehicle server, the task request including a terminal identifier, terminal location information and task information of the terminal.

The receiving module 1102 is used to receive a decision-making instruction sent by each unmanned aerial vehicle server, and select, according to an indication of each decision-making instruction as to whether the unmanned aerial vehicle server provides to the terminal a service corresponding to the task request, one server from among the unmanned aerial vehicle servers to provide the service, wherein the decision-making instructions being generated by the unmanned aerial vehicle servers according to the task requests and a target decision network.

The modules in the article surveillance device described above may be implemented in whole or in part by software, hardware, or a combination thereof. Each of the above modules may be embedded in or independent from a processor in a computer device in a hardware form, or may be stored in a memory in a computer device in a software form, so that the processor invokes and executes an operation corresponding to each of the modules.

In one embodiment, a computer device is provided, and may be a target unmanned aerial vehicle server, the internal structure diagram of which may be as shown in FIG. 12. The computer device includes a processor, a memory, an input/output (I/O) interface, and a communication interface. The processor, the memory and the input/output interface are connected via a system bus, and the communication interface is connected to the system bus via the input/output interface. The processor of the computer device is used to provide computing and control capabilities. The memory of the computer device includes a non-volatile storage medium and an internal memory. The non-volatile storage medium stores an operating system, a computer program, and a database. The internal memory provides an environment for running of the operating system and the computer program in the non-volatile storage medium. The database of the computer device is used to store service decision data. The input/output interface of the computer device is used to exchange information between the processor and an external device. The communication interface of the computer device is used to communicate with an external terminal via a network connection. The computer program, when executed by the processor, implements a service decision method.

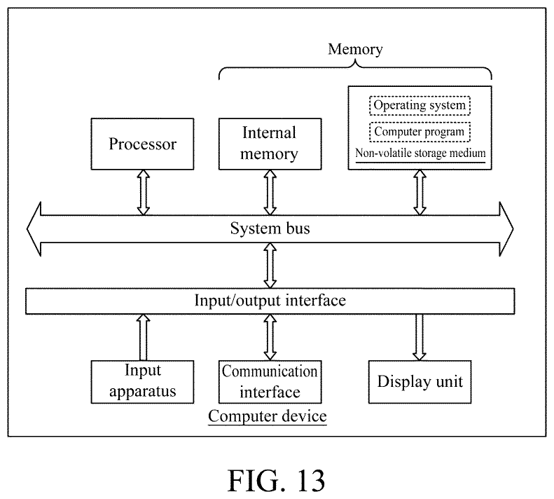

In one embodiment, a computer device is provided, and may be a terminal, the internal structure diagram of which may be as shown in FIG. 13. The computer device includes a processor, a memory, an input/output interface, a communication interface, a display unit, and an input device. The processor, the memory and the input/output interface are connected via a system bus, and the communication interface, the display unit and the input device are connected to the system bus via the input/output interface. The processor of the computer device is used to provide computing and control capabilities. The memory of the computer device includes a non-volatile storage medium and an internal memory. The non-volatile storage medium stores an operating system and a computer program. The internal memory provides an environment for running of the operating system and the computer program in the non-volatile storage medium. The input/output interface of the computer device is used to exchange information between the processor and an external device. The communication interface of the computer device is used to communicate with an external terminal in a wired or wireless manner, and the wireless manner may be implemented via WIFI, a mobile cellular network, near field communication (NFC), or other technologies. The computer program, when executed by the processor, implements a service decision method. The display unit of the computer device is used to form a visible image, and may be a display screen, a projection device, or a virtual reality imaging device. The display screen may be a liquid crystal display screen or an electronic ink display screen, and the input device of the computer device may be a touch layer covering the display screen, a key, a trackball, or a touch pad provided on a housing of the computer device, or an external keyboard, touch pad, or mouse.

It can be understood by those skilled in the art that the structures shown in FIG. 12 and FIG. 13 are merely block diagrams of partial structures related to the embodiments of the application, and do not constitute a limitation on a computer device to which the solutions of the present application are applied, and a specific computer device may include more or less components than those shown in the drawings, or some components may be combined, or have a different component arrangement.

In one embodiment, a computer device is provided, and includes a memory and a processor, the memory storing a computer program. In a possible embodiment, the computer device is the target unmanned aerial vehicle server, and the processor, when executing the computer program, implements the service decision method for a target unmanned aerial vehicle server.

In one embodiment, a computer device is provided, and includes a memory and a processor, the memory storing a computer program. In a possible embodiment, the computer device is the terminal, and the processor, when executing the computer program, implements the steps of the service decision method for a terminal.

The embodiments of the present application further provide a computer-readable storage medium. One or more non-volatile computer-readable storage media containing computer-executable instructions that, when executed by one or more processors, cause the processor(s) to perform the steps of the service decision method for a target server.

The embodiments of the present application further provide a computer-readable storage medium. One or more non-volatile computer-readable storage media containing computer-executable instructions that, when executed by one or more processors, cause the processor(s) to perform the steps of the service decision method for a terminal.

The embodiments of the present application further provide a computer program product containing instructions. The computer program product, when running on a computer, causes the computer to perform the service decision method for a target unmanned aerial vehicle server.

The embodiments of the present application further provide a computer program product containing instructions. The computer program product, when running on a computer, causes the computer to perform the service decision method for a terminal.

It should be noted that the user information (including, but not limited to, user device information, user personal information, etc.) and data (including, but not limited to, data for analysis, stored data, presented data, etc.) referred to in the present application are all information and data that are authorized by the user or sufficiently authorized by various parties, and the acquisition, use, and processing of relevant data need to comply with relevant laws and regulations and standards in relevant countries and regions.

Those of ordinary skill in the art can understand that all or part of the processes in the methods of the above embodiments may be implemented by a computer program instructing related hardware. The computer program may be stored in a non-volatile computer-readable storage medium, and when the computer program is executed, the computer program may include the processes of the above embodiments of the methods. Any references to memories, databases, or other media used in the embodiments provided in the present application may include at least one of non-volatile and volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM), an external cache memory, or the like. By way of illustration but not limitation, the RAM may take many forms, such as a static random access memory (SRAM), a dynamic random access memory (DRAM), or the like. The database involved in the embodiments provided in the present application may include at least one of a relational database and a non-relational database. The non-relational database may include a blockchain-based distributed database or the like, and is not limited thereto. The processor involved in the embodiments provided in the present application may be a general-purpose processor, a central processing unit, a graphics processor, a digital signal processor, a programmable logic device, a quantum computing-based data processing logic device, or the like, and is not limited thereto.

The technical features of the foregoing embodiments can be combined arbitrarily. For simplicity of description, all possible combinations of the technical features in the foregoing embodiments are not described, but should be regarded as falling within the scope of the description as long as there is no conflict in the combinations of the technical features.

The foregoing embodiments merely show several embodiments of the present application, and the descriptions thereof are specific and detailed, but cannot therefore be understood as limitations on the patent scope of the present application. It should be noted that, for those of ordinary skill in the art, several variations and improvements can be further made without departing from the concept of the present application, which all fall within the scope of protection of the present application. Therefore, the scope of protection of the present application should be defined by the appended claims.

1-10. (canceled)

11. A computer-implemented method, comprising:
receiving, by one or more processors, a task request from a terminal, wherein the task request comprises an identifier of the terminal, position information of the terminal, and/or task information of the terminal;
determining that the terminal lies within an overlapping service area between an unmanned aerial vehicle (UAV) server and one or more other UAV servers based on the position information;
generating, using a decision network, a service decision instruction based on the task request and the one or more other UAV servers, wherein the service decision instruction comprises an indication of whether the UAV server should service the task request; and
transmitting the service decision instruction to the terminal using the identifier of the terminal.

12. The computer-implemented method of claim 11, further comprising:
servicing the task request in response to a terminal selection of the UAV server based on the service decision instruction and service decision instructions transmitted to the terminal by the one or more other UAV servers.

13. The computer-implemented method of claim 12, wherein the service decision instruction and the service decision instructions transmitted to the terminal by the one or more other UAV servers only indicate one UAV server that should service the task request.

14. The computer-implemented method of claim 11, wherein the generating the service decision comprises:
calculating, using the decision network and based on state information of the UAV server and the task request, decision information of the UAV server; and
generating the service decision instruction based on the decision information.

15. The computer-implemented method of claim 14, wherein the decision information comprises an action decision of the UAV server, available computing resources of the UAV server, available bandwidth of the UAV server, and/or an estimated execution time for a task.

16. The computer-implemented method of claim 11, further comprising:
training the decision network by iterating over one or more training epochs using sample environment data comprising a plurality of task requests each corresponding to each of a plurality of state information sets of the UAV server.

17. The computer-implemented method of claim 16, wherein each state information set comprises a location of the UAV server, available computing resources of the UAV server, available bandwidth of the UAV server, and/or a number of users within a coverage area of the UAV server.

18. The computer-implemented method of claim 16, wherein the iterating over one or more training epochs comprises:
collecting experiences inside an experience pool by interacting with the sample environment data;
updating internal weights of the evaluation network based on evaluation values obtained by the evaluation network; and
updating internal weights of the decision network based on each of the collected experiences.

19. The computer-implemented method of claim 18, wherein the updating the internal weights of the decision network occurs after completing a full training epoch.

20. The computer-implemented method of claim 18, wherein the collecting experiences comprises:
inputting a first sample environment data into the decision network to obtain decision information of the UAV server;
evaluating the decision information using the evaluation network to obtain a final reward value,
determining a second sample environment data by applying the decision information to the first sample environment; and
storing the first sample environment data, the second sample environment data, the decision information, and the reward value inside the experience pool, wherein the experience pool comprises experiences collected from the UAV server and the one or more other UAV servers.

21. The computer-implemented method of claim 20, wherein:
the evaluation network comprises a first evaluation model and a second evaluation model, and
the updating the internal weights of the evaluation network comprises:
comparing a first evaluation value by the first evaluation model and a second evaluation value by the second evaluation value to obtain a minimum evaluation value,
calculating an error between the minimum evaluation value and a target evaluation value, and
updating the internal weights of the first evaluation model and the second evaluation model based on the calculated error using differential learning.

22. The computer-implemented method of claim 20, wherein the evaluation network is implemented using a multi-agent twin delayed deep deterministic policy gradient algorithm.

23. The computer-implemented method of claim 20, wherein the evaluating comprises:
calculating one or more reward and punishment values from the decision information and the first sample environment based on a plurality of constraints; and
aggregating the one or more calculated reward and punishment values to obtain a final reward value corresponding to the decision information.

24. The computer-implemented method of claim 23, further comprising:
weighting the one or more calculated reward and punishment values using a reward factor.

25. The computer-implemented method of claim 23, wherein the plurality of constraints are based on at least one of the available computing resources of the UAV server, the available bandwidth of the UAV server, the number of users within a coverage area of the UAV server, an estimated execution time for the task request by the UAV server, and an execution time of the current epoch.

26. The computer-implemented method of claim 11, wherein the task information comprises a data size, a computation strength, and/or a maximum allowable time delay for the task request.

27. A computer-implemented method comprising:
transmitting a task request to each of a plurality of unmanned aerial vehicle (UAV) servers within an overlapping coverage area accessible by a terminal, wherein the task request comprises an identifier of the terminal, position information of the terminal, and/or task information of the terminal;
receiving a plurality of service decision instructions from the plurality of UAV servers, wherein each of the plurality of service decision instructions comprises an indication of whether the corresponding UAV server should service the task request and wherein each of the plurality of service decision instructions is generated using a decision network based on the task request;
selecting a UAV server from the plurality of UAV servers to service the task request based on the plurality of service decisions; and
transmitting the selection and the task request to the UAV server to service the task request.

28. The computer-implemented method of claim 27, wherein the plurality of service decision instructions indicate a UAV server that should service the task request.

29. A service decision device comprising:
a receiving module configured to receive a task request sent by a terminal in an overlapping service area between an unmanned aerial vehicle (UAV) server and one or more other UAV servers, wherein the task request comprises an identifier of the terminal, position information of the terminal and/or task information of the terminal; and
a decision module configured to generate, using a decision network, a service decision instruction based on the task request,
wherein the service decision instruction comprises an indication of whether the UAV server should service the task request and to transmit the service decision instruction to the terminal using the identifier of the terminal, and
wherein the target decision instruction is used for the terminal to select among the UAV server and the one or more other UAV servers to service the task request based on the service decision instruction and service decision instructions transmitted by the one or more other UAV servers.

30. A service decision device comprising:
a sending module configured to transmit a task request to each of a plurality of unmanned aerial vehicle (UAV) servers within an overlapping coverage area accessible by a terminal, wherein the task request comprises an identifier of the terminal, position information of the terminal, and/or task information of the terminal; and
a receiving module configured to receive a plurality of service decision instructions from the plurality of UAV servers generated based on the task request using a decision network,
wherein each of the plurality of service decision instructions comprises an indication of whether the corresponding UAV server should service the task request and to select a UAV server from the plurality of UAV servers to service the task request based on the plurality of service decisions.
